(19) United States
(12) Patent Application Publication
(10) Pub. No.: US 2007/0036993 A1
(43) Pub. Date: Feb. 15, 2007

(54) Films and methods of forming films having polyorganosiloxane enriched surface layers

(76) Inventors: Mary Lucille DeLucia, Roswell, GA (US); Christian Lee Sanders, Decatur, GA (US); Lon Michael Edelman, Alpharetta, GA (US); Silverio Donato de la Cruz JR., Cumming, GA (US); Joerg Hendrix, Alpharetta, GA (US); Jessica King Bersted, LaGrange, GA (US)

Correspondence Address: Kimberly-Clark Worldwide, Inc., 401 North Lake Street, Neenah, WI, 54957-0349, US

(21) Appl. No.: 11/585,044

(22) Filed: Oct. 23, 2006

Related U.S. Application Data
(62) Division of application No. 10/725,143, filed on Dec. 1, 2003.

(51) Int. Cl. B32B 9/04; C08K 5/5419

(52) U.S. Cl. 428/447; 524/268; 525/100

(57) ABSTRACT

A breathable multilayered thermoplastic film that is a liquid barrier and has a WVTR of at least about 300 g/m²/24 hours and includes exterior layers that include from about 0.005 to about 0.2 weight percent of a polyorganosiloxane or a mixture of polyorganosiloxanes is provided.

This application is a divisional of application Ser. No. 10/725,143 entitled “Films and Methods of Forming Films Having Polyorganosiloxane Enriched Surface Layers” and filed in the U.S. Patent and Trademark Office on Dec. 1, 2003. The entirety of application Ser. No. 10/725,143 is hereby incorporated by reference.

### FILED OF THE INVENTION

The present invention relates to articles and methods of forming articles that include a polyorganosiloxane.

### BACKGROUND

Many products today require highly engineered components and yet, at the same time, must be produced at a cost consistent with limited use or disposability. By limited use or disposable, it is meant that the product and/or component is used only a small number of times or possibly only once before being discarded. Examples of such products include, but are not limited to, surgical and health care related products such as surgical drapes and gowns, disposable workwear such as coveralls and lab coats and personal care absorbent products such as diapers, training pants, incontinence garments, sanitary napkins, bandages, wipes and so forth. All of these products can and do utilize as components, films and fibrous nonwoven webs. While both materials are often used interchangeably, films tend to have greater barrier properties, especially to liquids, while fibrous nonwovens webs have, among other things, better tactile, comfort and aesthetic properties. When these materials are used in limited use and/or disposable products, the impetus for maximizing engineered properties while reducing cost is extremely high. To this end, it is often desirable to use either a film or a nonwoven to achieve the desired results because the combination often becomes more expensive. In the area of films, there have been previous attempts to make multilayer films with reduced thicknesses. One advantage in forming multilayer films is that specific properties can be designed into the film, and, by making the films multilayer, the more costly ingredients can be relegated to the outer layers where they are most likely to be needed.

In addition, in the production of a breathable filled film it is common to employ a significant percent (by weight) of filler such as, for example, calcium carbonate. As is known in the art, stretching of the filled film creates a fine pore network which allows the film to continue to act as a barrier to liquids and particulate matter yet allows air and water vapor to pass therethrough. In order to obtain more uniform barrier and vapor transmission properties throughout the film it is desirable to have the filler equally distributed throughout the film. Thus, although such breathable barriers may act as a barrier to liquids and particulate matter they may themselves be a source of unwanted particles (i.e. the filler) which can be a source of die lip contamination and buildup. This filler accumulation and/or detachment may also be an undesirable cause of defects in various applications or articles employing the barrier fabric. A filled film which retains good breathability and low defect levels produced without die lip buildup is therefore desirable. In this regard, there exists a continuing need for a multilayer film having outer layers with little or no filler, yet which does not significantly reduce the breathability of the multilayer film. Moreover, many filled films fail to provide good adhesion to additional layers, such as, for example, nonwoven fabrics. Multilayer films which are capable of providing good adhesion to a support fabric without loss of breathability are likewise needed.

As mentioned, production of such films and nonwovens has, however, been accompanied by persistent problems of buildup of the composition being extruded on the die tip causing machine downtime for cleanup, frequently after only a few hours of operation. Various mechanisms are known to facilitate the cleaning and maintenance of dies used for the extrusion of polymer materials, while minimizing downtime. Molten polymers are extruded through dies to form films, strands, nonwoven webs, and other finished polymer forms. Particularly with polymer compositions containing fillers, as polymer exits the die, some of the polymer composition clings to the die openings or “lips,” accumulating on the exterior surface of the die. Die lip build-up gradually increases until it accumulates to a point where it breaks off, possibly causing a defect in the product, which can be, for example, in the form of thin spots or tears or otherwise deleterious effects on the texture or other esthetic properties of the product as well as other defects that are the result of stoppage. Considerable engineering goes into the design of dies and selection of extrusion compositions to minimize this build-up. Diverging, converging, radiused, and angled die lip geometries all are examples of methods developed to minimize this build-up. However, no die design completely eliminates it. It is common practice to temporarily halt the extrusion operation to perform maintenance on the die to remove this build-up. Stoppages adversely affect production yields, increase costs and may also adversely affect product uniformity. Accordingly, it is advantageous to minimize work stoppages.

Methods of reducing die lip build up or accumulation of extrudate contamination during extrusion have been attempted. For example, U.S. Pat. No. 6,245,271 describes a method of reducing die lip build up during extrusion that utilize a die having die lips with a radius of curvature of from about 0.5 mils to about 3 mils. It would be advantageous to develop a method of further reducing die lip build up during extrusion. It would also be advantageous to develop a method of reducing die lip build up during extrusion that does not require modification of existing equipment.

### SUMMARY

The present invention provides methods for producing films. In certain embodiments, the process includes: providing a molten thermoplastic composition, the molten thermoplastic composition comprising an amount of a polyorganosiloxane or a mixture of polyorganosiloxanes effective to reduce die lip buildup extruding the thermoplastic composition through die lips to form a film.
The polyorganosiloxane may be selected from the group of polyorganosiloxanes of the following formula: 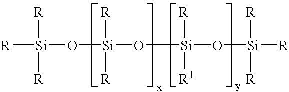
wherein R is an alkyl radical and R¹ is a monovalent organic radical containing at least one ethylene oxide group, vicinal epoxy group or amino group and x and y are independently selected from the group of positive integers. The amount of polyorganosiloxane in the thermoplastic composition may range from about 0.005 to about 0.2 weight percent of a polyorganosiloxane or a combination of polyorganosiloxanes relative to the total weight of the molten thermoplastic composition. More desirably, the amount of polyorganosiloxane or combination of polyorganosiloxanes in the molten thermoplastic composition may range from about 0.01 to about 0.15 weight percent of a polyorganosiloxane or a combination of polyorganosiloxanes relative to the total weight of the molten thermoplastic composition. And, even more desirably, the amount of polyorganosiloxane or a mixture of polyorganosiloxanes in the molten thermoplastic composition may range from about 0.01 to about 0.10 weight percent of a polyorganosiloxane or a combination of polyorganosiloxanes relative to the total weight of the molten thermoplastic composition or even as low as about 0.01 to about 0.075 weight percent of a polyorganosiloxane or a combination of polyorganosiloxanes relative to the total weight of the molten thermoplastic composition. In certain embodiments, the film is a multilayer film that includes at least one interior layer and one or two exterior layers wherein the polyorganosiloxane is included in the exterior layers at an amount that ranges from about 0.01 to about 0.2 weight percent of the exterior layers.

The present invention also provides thermoplastic films that include a surface that comprises from about 0.01 to about 0.2 weight percent of a polyorganosiloxane or a mixture of polyorganosiloxanes relative to the total weight of the region proximate the surface of the thermoplastic film. The polyorganosiloxane or polyorganosiloxanes are selected from the group of polyorganosiloxanes of the following formula: 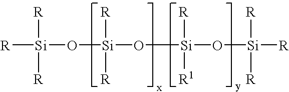
wherein R is an alkyl radical and R¹ is a monovalent organic radical containing at least one ethylene oxide group, vicinal epoxy group or amino group and x and y are independently selected from the group of positive integers. The surface may include from about 0.01 to about 0.2 weight percent of a polyorganosiloxane relative to the total weight of the surface of the region proximate the surface of the thermoplastic film is an enriched region relative to the interior of the film and wherein the interior of the film comprises less than 0.01 of a polyorganosiloxane relative to the total weight of the of the region proximate the interior of the thermoplastic film. Both surfaces of the thermoplastic film may include from about 0.01 to about 0.2 weight percent of a polyorganosiloxane relative to the total weight of the regions proximate the surfaces of the thermoplastic film. For example, both surfaces may include from about 0.01 to about 0.2 weight percent of a polyorganosiloxane relative to the total weight of regions proximate the surfaces of the thermoplastic film relative to the interior of the film. Thus, the surface layers are additive-enriched regions relative to the interior which comprises less than 0.01 weight percent of a polyorganosiloxane, desirably less than 0.0001 weight percent, relative, to the total weight of the film. The thermoplastic may be a polyolefin or include a polyolefin or a mixture of polyolefins, for example, homopolymers and copolymers of ethylene, homopolymers and copolymers of propylene and so forth.

In certain desirable embodiments, the present invention provides breathable multilayered thermoplastic films and compositions of multilayer films In such desirable embodiments, the multilayer film includes: a core layer that includes a first extrudable thermoplastic composition wherein the first extrudable thermoplastic composition comprises an extrudable thermoplastic polymer and an inorganic filler and the core layer has a first exterior surface and a second exterior surface, a first skin layer and a second skin layer wherein the first skin layer and the second skin layer include a second extrudable thermoplastic composition and further wherein the second extrudable thermoplastic composition includes an extrudable thermoplastic polymer and from about 0.01 to about 0.2 weight percent of a polyorganosiloxane or a mixture of polyorganosiloxanes relative to the total weight of the second extrudable thermoplastic composition. The first skin layer is attached to the first exterior surface of the core layer and the second skin layer is attached to the second exterior surface of the core layer to form the multilayer film and the multilayer film defining an overall thickness, the first skin layer defining a first skin layer thickness and the second skin layer defining a second skin layer thickness wherein the first skin thickness and the second skin thickness comprise less than about 20 percent of the overall thickness, with the overall thickness not exceeding about 30 micrometers. Desirably, the multilayer film is a liquid barrier and has a WVTR of at least about 300 g/m²/24 hours. The polyorganosiloxanes are selected from the group of polyorganosiloxanes of the following formula: 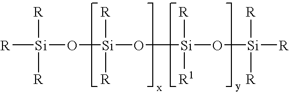
wherein R is an alkyl radical and R¹ is a monovalent organic radical containing at least one ethylene oxide group, vicinal epoxy group or amino group and x and y are independently selected from the group of positive integers. The films can be formed by coextrusion. The first skin layer may have a thickness greater than about 0.5 micron and less than about 2.7 micron and the second skin layer may have a thickness greater than about 0.5 micron and less than about 2.7 micron. The second extrudable thermoplastic composition may include from about 1 weight percent to about 20 weight percent of an inorganic filler or a combination of inorganic fillers total weight of the second extrudable thermoplastic composition. The second extrudable thermoplastic composition may include a copolymer of ethylene and vinyl acetate. The second extrudable thermoplastic composition may also include a polypropylene-ethylene random copolymer or a low density polyethylene homopolymer. The first extrudable thermoplastic composition may include from about 30 weight percent to about 80 weight percent of an inorganic filler or a combination of inorganic fillers total weight of the first extrudable thermoplastic composition. The first extrudable thermoplastic composition may include a linear low density polyethylene. In certain desirable embodiments, the multilayered thermoplastic film has a liquid barrier and may be breathable with a WVTR of at least about 500 g/m²/124 hours.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in this specification, which makes reference to the appended figures in which:

FIG. 1 is a cross-sectional side view of a multilayer film according to certain embodiments of the present invention. The right side of the film has been split apart to facilitate description of the multilayer film.

FIG. 2 is a cross-sectional side view of a laminate of a nonwoven and a multilayer film according to certain other embodiments the present invention.

FIG. 3 is a schematic side view of a process for forming a multilayer film according to the present invention and a laminate of a nonwoven and a multilayer film according to certain embodiments of the present invention.

FIG. 4 is a partially cut away top plan view of an exemplary personal care absorbent article, in this case a diaper, which may utilize a laminate of a nonwoven and a multilayer film according to the present invention.

### DEFINITIONS

As used herein and in the claims, the term “comprising” is inclusive or open-ended and does not exclude additional unrecited elements, compositional components, or method steps.

As used herein the term “recover” refers to a contraction of a stretched material upon termination of a biasing force following stretching of the material by application of the biasing force. For example, if a material having a relaxed, unbiased length of 1 inch (2.5 cm) is elongated fifty percent by stretching to a length of 1.5 inches (3.75 cm), the material would be elongated 50 percent and would have a stretched length that is 150 percent of its relaxed length or stretched 1.5×. If this exemplary stretched material contracted, that is recovered to a length of 1.1 inches (2.75 cm) after release of the biasing and stretching force, the material would have recovered 80 percent of its 0.5 inch (1.25 cm) elongation. Percent recovery may be expressed as [(maximum stretch length−final sample length)/(maximum stretch length−initial sample length)]×100.

As used herein the term “nonwoven” fabric or web means a web having a structure of individual fibers or threads which are interlaid, but not in an identifiable manner as in a knitted fabric. Nonwoven fabrics or webs have been formed by many processes such as for example, meltblowing processes, spunbonding processes, hydroentangling, air-laid and bonded carded web processes.

As used herein the term “extensible” means elongatable or stretchable in at least one direction.

As used herein the term “neck softening” means neck stretching carried out without the addition of heat, i.e. at ambient temperature, to the material as it is stretched in the machine direction. In neck stretching or softening, a fabric is referred to, for example, as being stretched by 20%. This means it is stretched in the machine direction until its width is 80% of its original unstretched width.

As used herein, the term “neckable material” means any material which can be necked.

As used herein, the term “necked material” refers to any material which has been constricted in at least one dimension by processes such as, for example, drawing or gathering.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3, 502,763 to Hartman, U.S. Pat. No. 3,542,615 to Dobo et al, and U.S. Pat. No. 5,382,400 to Pike et al. each being incorporated herein by reference in its entirety. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned WO Patent Application. 98/23804 to Marmon et al. and U.S. Pat. No. 5,759,926 to Pike et al.

As used herein the term “meltblown fibers” means fibers of polymeric material which are generally formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter. Thereafter, the meltblown fibers can be carried by the high velocity gas stream and are deposited on a collecting surface to form a web of randomly dispersed meltblown fibers. Such a process is disclosed, for example, in U.S. Pat. No. 3,849,241 to Butin et al. and U.S. Pat. No. 5,271,883 to Timmons et al. each being incorporated herein by reference in its entirety. Meltblown fibers may be continuous or discontinuous, are generally smaller than 10 microns in average diameter, and are generally tacky when deposited onto a collecting surface.

As used herein “multilayer nonwoven laminate” means a laminate of two or more layers in which at least one of the layers is a nonwoven material such as, for instance, a spunbond layer. For example, a multilayer nonwoven laminate may include a spunbond/meltblown/spunbond (SMS) laminate, or a laminate in which at least one of the layers is a nonwoven and the other layer(s) is another material such as a film in a spunbond/film laminate (SF). Examples of multilayer nonwoven laminates are disclosed in U.S. Pat. No. 4,041,203 to Brock et al., U.S. Pat. No. 5,178,931 to Perkins et al. and U.S. Pat. No. 5,188,885 to Timmons et al. each being incorporated by reference in its entirety. Such a laminate may be made by sequentially depositing onto a moving forming belt first a spunbond fabric layer, then a meltblown fabric layer and last another spunbond layer and then bonding the laminate such as by thermal point bonding as described below. Alternatively, the fabric layers may be made individually, collected in rolls, and combined in a separate bonding step.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” includes all possible spacial configurations of the molecule. These configurations include, but are not limited to isotactic, syndiotactic and random symmetries.

As used herein, the term “machine direction” or MD means the length of a fabric in the direction in which it is produced. The term “cross machine direction” or CD means the width of fabric, i.e. a direction generally perpendicular to the MD.

As used herein, “ultrasonic bonding” means a process performed, for example, by passing the fabric between a sonic horn and anvil roll as illustrated in U.S. Pat. No. 4,374,888 to Bomslaeger.

As used herein “point bonding” means bonding one or more layers of fabric at a plurality of discrete bond points. For example, thermal point bonding generally involves passing one or more layers to be bonded between heated rolls such as, for example an engraved pattern roll and a smooth calender roll. The engraved roll is patterned in some way so that the entire fabric is not bonded over its entire surface, and the anvil roll is usually flat. As a result, various patterns for engraved rolls have been developed for functional as well as aesthetic reasons. One example of a point bond pattern is the Hansen Pennings or “H&P” pattern with about a 30 percent bond area when new and with about 200 bonds/square inch as taught in U.S. Pat. No. 3,855,046 to Hansen and Pennings, incorporated by reference herein in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). Another typical point bonding pattern is the expanded Hansen Pennings or “EHP” bond pattern which produces a 15 percent bond area when new with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15 percent when new. Yet another common pattern is the C-Star pattern which has, when new, a bond area of about 16.9 percent. The C-Star pattern has a cross-directional bar or “corduroy” design interrupted by shooting stars. Other common patterns include a diamond pattern with repeating and slightly offset diamonds with about a 16 percent bond area and a wire weave pattern looking as the name suggests, e.g. like a window screen, with about a 15 percent bond area. A further pattern is the “S-weave” pattern having about a 17 percent bond area when new and a baby objects pattern having about a 12 percent bond area when new. Such bonding pattern is further described in U.S. Pat. No. 5,599,420 to Yeo et al., incorporated by reference herein in its entirety. Typically, the percent bonding area is less than about 50 percent and more desirably varies from around 10 percent to around 30 percent of the area of the fabric laminate web.

As used herein “elastic” or “elastomeric” refers to material which, upon application of a biasing force, is extensible or elongatable in at least one direction and returns approximately to its original dimensions after the force is removed. For example, an elongated material having a biased length which is at least 50 percent greater than its relaxed unbiased length, and which will recover to within at least 50 percent of its elongation upon release of the elongating force. A hypothetical example would be a one (1) inch sample of a material which is elongatable to at least 1.50 inches and which, upon release of the biasing force, will recover to a length of not more than 1.25 inches.

As used herein the term “percent stretch” refers to the ratio determined by measuring the increase in the stretched dimension and dividing that value by the original dimension. i.e. (increase in stretched dimension/original dimension)×100.

As used herein the term “set” refers to retained elongation in a material sample following the elongation and recovery, i.e. after the material has been stretched and allowed to relax.

As used herein the term “percent set” is the measure of the amount of the material stretched from its original length after being cycled. The remaining strain after the removal of the applied stress is measured as the percent set. The percent set is where the retraction curve of a cycle crosses the elongation axis, and as further discussed below.

As used herein, the term “inelastic” or “nonelastic” refers to any material which does not fall within the definition of “elastic” above.

As used herein, the term “breathable” refers to a material which is permeable to water vapor having a minimum WV(TR (water vapor transmission rate) of about 300 g/m² /24 hours, more desirably having a minimum WvTR of about 1000 g/m² /24 hours. The WVTR of a fabric, in one aspect, gives an indication of how comfortable a fabric would be to wear. WVTR is measured as indicated below and the results are reported in grams/square meter/24 hours. However, often applications of breathable barriers desirably have higher WVTRs and breathable barriers of the present invention can have WVTRs exceeding about 1,200 g/m² /24 hours, 1,500 g/m² /24 hours, 1,800 g/m² /24 hours or even exceeding 2,000 g/m² /24 hours. The water vapor transmission rate (WVTR) for sample materials is calculated in accordance with the following test method. Circular samples measuring three inches in diameter were cut from each of the test materials and a control which was a piece of CELGARD® 2500 film from Hoechst Celanese Corporation of Sommerville, N.J. CELGARD® 2500 film is a microporous polypropylene film. Three samples were prepared for each material. The test dish was a number 60-1 Vapometer pan distributed by ThwingAlbert Instrument Company of Philadelphia, Pa. One hundred milliliters of water were poured into each Vapometer pan and individual samples of the test materials and control material were placed across the open tops of the individual pans. Screw-on flanges were tightened to form a seal along the edges of the pan, leaving the associated test material or control material exposed to the ambient atmosphere over a 6.5 centimeter diameter circle having an exposed area of approximately 33.17 square centimeters. The pans were placed in a forced air oven at about 100° F. (38° C.) or 1 hour to equilibrate. The oven was a constant temperature oven with external air circulating through it to prevent water vapor accumulation inside. A suitable forced air oven is, for example, a Blue M Power-O-Matic 60 oven distributed by Blue M. Electric Company of Blue Island, Ill. Upon completion of the equilibration, the pans were removed from the oven, weighed and immediately returned to the oven. After 24 hours, the pans were removed from the oven and weighed again. The preliminary test water vapor transmission rate values were calculated with the following equation:

Test WVTR=(grams weight loss over 24 hours)×315.5 g/m² /24 hours The relative humidity within the oven was not specifically controlled. Under the predetermined set conditions of about 100° F. (38° C.) and ambient relative humidity, the WVTR for the CELGARDO 2500 control has been defined to be 5000 grams per square meter for 24 hours. Accordingly, the control sample was run with each test and the preliminary test values were corrected to set conditions using the following equation:
WVTR=(Test VVVTR/control WVTR)×(5000g/m²/24 hours).

As used herein “peel strength” is measured using a Peel Test:. In peel or delamination testing a laminate is tested for the amount of tensile force which will pull the layers of the laminate apart. Values for peel strength are obtained using a specified width of fabric, clamp jaw width and a constant rate of extension. For samples having a film side, the film side of the specimen is covered with masking tape or some other suitable material in order to prevent the film from ripping apart during the test. The masking tape is on only one side of the laminate and so does not contribute to the peel strength of the sample. This test uses two clamps, each having two jaws with each jaw having a facing in contact with the sample, to hold the material in the same plane, usually vertically, separated by 2 inches to start. The sample size is 4 inches wide by as much length as necessary, usually at least 6 inches, to delaminate enough sample length. The jaw facing size is 1 inch high by at least 4 inches wide, and the constant rate of extension is 300 mm/min. The sample is delaminated by hand a sufficient amount to allow it to be clamped into position and the clamps move apart at the specified rate of extension to pull the laminate apart. The sample specimen is pulled apart at 1800 mm of separation between the two layers and the peel strength reported as an average of peak load in grams. Measurement of the force is begun when 16 mm of the laminate has been pulled apart and continues until a total of 170 mm has been delaminated. The Sintech 2 tester, available from the Sintech Corporation of Cary, N.C. , the Instron Model TM, available from the Instron Corporation of Canton, Mass., or the Thwing-Albert Model INTELLECT 11 available from the Thwing-Albert Instrument Co. of Philadelphia., Pa., may be used- for this test. Results are reported as an average of three specimens and may be performed with the specimen in the cross direction (CD) or the machine direction (MD). The test is conducted at in a controlled laboratory atmosphere of 23±2° C. (73.4±3.6° F. ) and 50±5% relative humidity, unless otherwise specified. The material should be tested and measured only after sufficient time has been allowed for the specimen(s) to reach essential equilibrium with the ambient atmosphere.

As used herein the term “blend” means a mixture of two or more polymers. In some instances the components of the blend are not compatible but have been melt mixed under high shear to provide a homogeneous blend.

As used herein the term “compatibilizer” means a material which assists in the adhesion or blending of two normally incompatible materials.

As used herein, the term “garment” means any type of apparel which may be worn. This includes industrial work wear and coveralls, undergarments, pants, shirts, jackets, gloves, socks, and so forth.

As used herein, the term “personal care product” means diapers, training pants, absorbent underpants, adult incontinence products, and feminine hygiene products.

As used herein, the term “high performance elastomer” means an elastomer having a level of hysteresis of less than about 75 percent as determined by the method described below and desirably, less than about 60 percent for a sample at 10 gsm. The hysteresis value is determined by first elongating a sample to an ultimate elongation of a given percentage (such as 50 or 100 percent) and then allowing the sample to retract to an amount where the amount of resistance is zero. For the purposes of this application, the term ultimate elongation should be understood to mean a predefined elongation percentage. For the purposes of this application, the hysteresis value determining numbers as used in the definition of high and low performance elastomers, (and as further explained below) are read at the 30 percent and 50 percent total ultimate elongation in the cross-machine direction.

As used herein, the term “low performance elastomer” means an elastomer having a level of hysteresis of greater than about 75 percent, determined by the method described below.

As used herein, the term “precursor film” means a filled film which has not yet been stretched or oriented so as to separate its particulate filler from its polymer component to thereby produce micropores.

As used herein, the term “product film” means a microporous filled film which has been stretched or oriented so that voids have formed around its particulate filler components so as to separate its particulate filler from the polymer components. The product film may be used in this form or subsequently used in a laminate.

As used herein, a “filler” is meant to include particulates and/or other forms of materials which can be added to a film polymer extrusion material which will not chemically interfere with or adversely affect the extruded film and further which are capable of being uniformly dispersed throughout the film. Generally the fillers will be in particulate form with average particle sizes in the range of about 0.1 to about 10 microns, desirably from about 0.1 to about 4 microns.

As used herein, the term “particle size” describes the largest dimension or length of the filler particle.

As used herein, the term “bicomponent fibers” refers to fibers which have been formed from at least two polymer sources extruded from separate extruders but spun together to form one fiber. Bicomponent fibers are also sometimes referred to as conjugate fibers or multicomponent fibers. The polymers are arranged in substantially constantly positioned distinct zones across the cross-sections of the bicomponent fibers and extend continuously along the length of the bicomponent fibers. The configuration of such a bicomponent fiber may be, for example, a sheath/core arrangement wherein one polymer is surrounded by another, or may be a side-by-side arrangement, a pie arrangement, or an “islands-in-the-sea” arrangement. Bicomponent fibers are taught by U.S. Pat. No. 5,108,820 to Kaneko et al., U.S. Pat. No. 4,795,668 to Krueger et al., U.S. Pat. No. 5,540,992 to Marcher et al., and U.S. Pat. No. 5,336,552 to Strack et al., each being incorporated herein by reference in its entirety. Bicomponent fibers are also taught by U.S. Pat. No. 5,382,400 to Pike et al. For two component fibers, the polymers may be present in ratios of 75/25, 50/50, 25/75 or any other desired ratio.

### DETAILED DESCRIPTION

Reference now will be made in detail to various embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield still a further embodiment. Thus, it is intended that the present invention covers such modifications and variations as come within the scope of the appended claims and their equivalents.

The present invention provides methods for reducing die lip buildup during extrusion, especially during extrusion of films and more especially during extrusion of multilayer films. In certain embodiments, the melt extrusion process includes: providing a molten thermoplastic composition, the molten thermoplastic composition comprising an amount of a polyorganosiloxane or a mixture of polyorganosiloxanes effective to reduce die lip buildup and extruding the molten thermoplastic composition through die lips to form a film. The polyorganosiloxane is selected from the group of polyorganosiloxanes of the following formula: 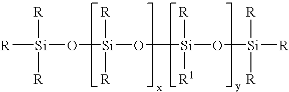
wherein R is an alkyl radical and R¹ is a monovalent organic radical containing at least one ethylene oxide group, vicinal epoxy group or amino group and x and y are independently selected from the group of positive integers. Desirably, the polyorganosiloxane or a mixture of polyorganosiloxanes is concentrated at the surface of the film in order to increase the effect of the polyorganosiloxane or a mixture of polyorganosiloxanes while minimizing the total amount of polyorganosiloxane that is needed to reduce die lip build up. More desirably, the polyorganosiloxane or a mixture of polyorganosiloxanes is included in one or both surface layers. The amount of polyorganosiloxane in the molten thermoplastic composition at the surface may range from about 0.01 to about 0.2 weight percent of a polyorganosiloxane or a combination of polyorganosiloxanes relative to the total weight of the molten thermoplastic composition. More desirably, the amount of polyorganosiloxane or combination of polyorganosiloxanes in the molten thermoplastic composition may range from about 0.01 to about 0.15 weight percent of a polyorganosiloxane or a combination of polyorganosiloxanes relative to the total weight of the molten thermoplastic composition. And, even more desirably, the amount of polyorganosiloxane or a mixture of polyorganosiloxanes in the molten thermoplastic composition may range from about 0.01 to about 0.10 weight percent of a polyorganosiloxane or a combination of polyorganosiloxanes relative to the total weight of the molten thermoplastic composition or even as low as about 0.01 to about 0.075 weight percent of a polyorganosiloxane or a combination of polyorganosiloxanes relative to the total weight of the molten thermoplastic composition.

In certain embodiments, the present invention provides multilayer films that include the silicone additive, for example the polyorganosiloxane, in at least one exterior layer, desirably both exterior layers, of the multilayer film. For example, the present invention provides three-layer breathable films that can be extruded and that reduce die lip build up during extrusion of the of the multilayer film. Generally, films of the present invention, include from about 0.01 to about 0.2 weight percent of a polyorganosiloxane on at least one surface, desirably both surfaces of the film. The polyorganosiloxane can be provided on the surface as an enriched zone in a monolayer or multilayer film or can be provide in the exterior layer or layers of a multilayer film. Multilayer films are known and methods of making multilayer films are known. Breathable multilayer films and methods of making breathable multilayer films are described in U.S. Pat. Nos. 6,075,179; 6,309,736 and 6,479,154 which are hereby incorporated by reference herein in their entirety. In one embodiment, the present invention provides a multilayer breathable film that is elastic and includes a polyorganosiloxane additive in the outer layers for improved processability. The film can be a polyolefin, for example a polymer or copolymer of ethylene and/or propylene.

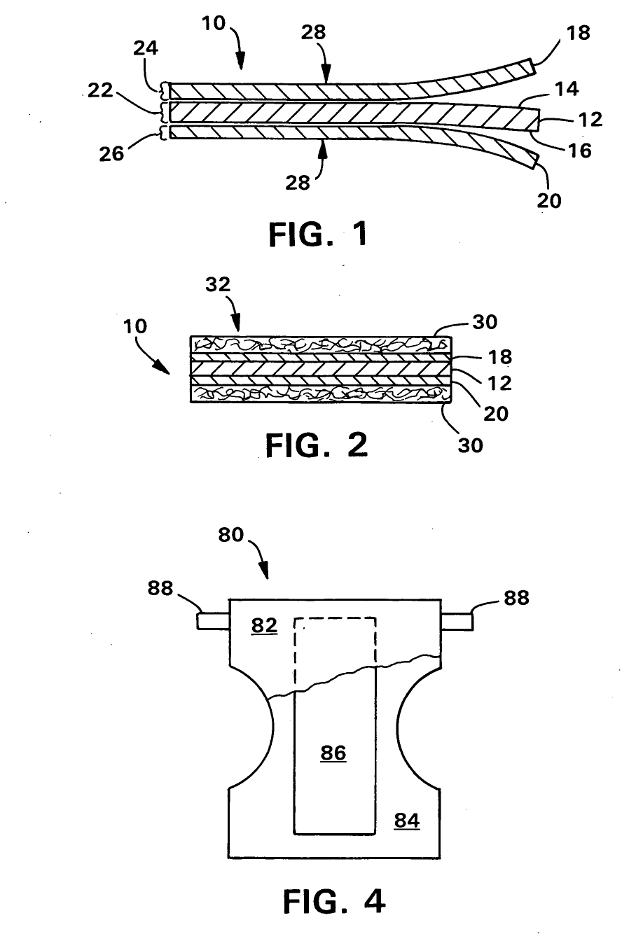

In an exemplary embodiment, the present invention provides films and methods of making films that have reduced die lip build up. Films of the present invention include multilayer films, that is, films having two or more layers as well as such films laminated to support layers such as, for example, fibrous nonwoven webs. The present invention is described by way of illustration as a three layer film. Referring to FIG. 1, there is shown, not to scale, a multilayer film 10 which, for purposes of illustration, has been split apart at the right side of the drawing. The multilayer film 10 includes a core layer 12 made from an extrudable thermoplastic polymer such as a polyolefin, including copolymers and/or blends thereof. The core layer 12 has a first exterior surface 14 and a second exterior surface 16. The core layer also has a core thickness 22. Attached to the first exterior surface 14 of the core layer 12 is a first skin layer 18 which has a first skin thickness 24. Attached to the second exterior surface 16 of the core layer 12 is an optional second skin layer 20 which has a second skin thickness 26. In addition, the multilayer film 10 has an overall thickness 28. Such multilayer films 10 can be formed by a wide variety of processes well known to those of ordinary skill in the film forming industry. Two particularly advantageous processes are cast film coextrusion processes and blown film coextrusion processes. In such processes, the layers are formed simultaneously and exit the die and are extruded in a multilayer form. Methods of extruding polymer compositions are generally known and include, but are not limited to: extrusion, including but not limited to film extrusion and foam extrusion, multilayer film extrusion, coextrusion; fiber spinning, including but not limited to spunbond and meltblown. A method of multilayer extrusion, i.e. extruding a multilayer film, is described and a multilayer extrusion process is schematically illustrated in U.S. Pat. No. 6,245,271 which is hereby incorporated by reference herein in its entirety. For more information regarding such processes, see, for example, U.S. Pat. Nos. 4,522,203; 4,494,629 and 4,734,324 which are also incorporated herein by reference in their entirety.

In certain desirable embodiments, the present invention allows the ability to utilize a more generic core layer 12 in conjunction with thinner and more specially designed skin layers that include a polyorganosiloxane to provide multilayer films that are produced with reduced die lip build up. The effective amount of polyorganosiloxane needed to reduce die lip build up can be minimized by including one or more polyorganosiloxanes in the skin layers only and not the interior layer(s), thus reducing the total amount of polyorganosiloxane in the film. The core layer 12 and the skin layers 18 and 20 may be formed from any polymers which are capable of being utilized in multilayer film constructions including, but are not limited to, polyolefins including homopolymers, copolymers, and/or blends. Suggested polyolefins include, but are not limited to, polymers and copolymers or ethylene such low density polyethylenes and ethylene/vinyl acetate copolymers, polymers and copolymers or propylene and so forth.

The core layer 12, which desirably makes up between about 85 and 98 percent of the overall film, is desirably made from an elastomeric thermoplastic polymer, for example an extrudable low performance elastomeric polymer or a mixture of said polymers, such as polyolefins. The core layer is desirably comprised of polyethylene. Suggested polyethylene resins include DOWLEX 2517 linear low-density polyethylene (LLDPE) and DOWLEX 2047 LLDPE available from Dow Chemical of Midland, Mich.; Exxon LD761.36 ethylene/vinyl acetate (EVA) resin and Exxon LD755.12 EVA resin available from Exxon Mobil of Houston Texas; and Basell KS357P propylene-ethylene copolymer available from Basell Polyolefins of Elkton, Md., and single site/metallocene-catalyzed polyethylene available under the trade names Dow ENGAGE EG8200 and Dow AFFINITY PL 1845 which are available from the Dow Chemical Company of Midland, Mich. Such polymers, which are known in the art as “metallocene”, “single-site” or “constrained geometry” catalyzed polymers, are described in U.S. Pat. No. 5,472,775 to Obijeski et al. and assigned to the Dow Chemical Company, the entire contents of which are incorporated herein by reference. The metallocene process generally uses a metallocene catalyst which is activated, i.e. ionized, by a co-catalyst. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, and zirconocene dichloride, among others. A more exhaustive list of such compounds is included in U.S. Pat. No. 5,374,696 to Rosen et al. assigned to the Dow Chemical Company. Such compounds are also discussed in U.S. Pat. No. 5,064,802 to Stevens et al. also assigned to Dow. However, numerous other metallocene, single-site and/or similar catalyst systems are known in the art; see for example, U.S. Pat. No. 5,539,124 to Etherton et al.; U.S. Pat. No. 5,554,775 to Krishnamurti et al.; U.S. Pat. No. 5,451,450 to Erderly et al. and The Encyclopedia of Chemical Technology, Kirk-Othemer, Fourth Edition, vol. 17, Olefinic Polymers, pp. 765-767 (John Wiley & Sons 1996); the entire content of the aforesaid patents being incorporated herein by reference. One particular suggested core layer composition is a mixture of polyolefin resins that includes DOWLEX 2517 linear low-density polyethylene (LLDPE) and DOWLEX 2047 LLDPE, Exxon LD761.36 EVA resin and weight percent of Exxon LD755.12 EVA resin and Basell KS357P propylene-ethylene copolymer. Still other suggested polymer resins that can be used to form the core layer include: EXXON 9302 random copolymer from Exxon Chemical Company; Himont KS059 CATALLOY olefinic thermoplastic elastomer from Himont USA of Wilmington, Del.; and Quantum NA206 low density polyethylene from Quantum Chemical Corporation of New York, N.Y.

The cost of the core layer 12 may also be reduced by adding one or more types of fillers to the core layer polymer extrusion blend. Both organic and inorganic fillers may be used. The fillers should be selected so as to not chemically interfere with or adversely affect the extruded film. These fillers can be used to reduce the amount of polymer being used for the core layer 12 and/or to impart particular properties such as breathability and/or odor reduction. For example, one or more types of fillers should desirably be added to the core layer polymer extrusion blend. Both organic and inorganic fillers are contemplated for use with the present invention, provided that they do not interfere with the film forming process and/or subsequent laminating processes. Examples of fillers include calcium carbonate (CaCO₃), various clays, silica (SiO₂), alumina, barium sulfate, sodium carbonate, talc, magnesium sulfate, titanium dioxide, zeolites, aluminum sulfate, cellulose-type powders, diatomaceous earth, gypsum, magnesium sulfate, magnesium carbonate, barium carbonate, kaolin, mica, carbon, calcium oxide, magnesium oxide, aluminum hydroxide, pulp powder, wood powder, cellulose derivatives, polymeric particles, chitin and chitin derivatives. The filler particles may optionally be coated with a fatty acid, such as stearic acid or behenic acid, and/or other material in order to facilitate the free flow of the particles (in bulk) and their ease of dispersion into the polymer. Particularly useful fillers include calcium carbonate fillers sold under the brand names SUPERCOAT by Imerys of Roswell, Georgia and OMYACARB by OMYA Inc. of Proctor, Vermont. The filled film will desirably contain at least 35 percent filler based upon the total weight of the film layer, more desirably from about 50 percent to about 65 percent by weight filler. Due to the nature of the polymer blend, roll blocking can occur when less than about 50 percent filler is utilized, roll blocking being the sticking which occurs between precursor film sheets when they are unwound from a roll. Thus, where lower levels of filler are used, additional processing aids and/or modification of the processing may be necessary to prevent such blocking. Additionally, calcium carbonate filler is used to provide breathability.

In addition, the breathable filled core layer of the film may optionally include one or more stabilizers. Desirably the filled-film includes an anti-oxidant such as, for example, a hindered phenol stabilizer. Commercially available anti-oxidants include, but are not limited to, IRGANOX E 17 (a -tocopherol) and IRGANOX 1076 (octodecyl 3,5-di-tert-butyl 4-hydroxyhydrocinnamate) which are available from Ciba Specialty Chemicals of Tarrytown, N.Y. In addition, other stabilizers or additives which are compatible with the film forming process, stretching and any subsequent lamination steps, may also be employed with the present invention. For example, additional additives may be added to impart desired characteristics to the film such as, for example, melt stabilizers, processing stabilizers, heat stabilizers, light stabilizers, heat aging stabilizers and other additives known to those skilled in the art. Generally, phosphite stabilizers (i.e. IRGAFOS 168 available from Ciba Specialty Chemicals of Tarrytown, N.Y. and DOVERPHOS available from Dover Chemical Corp. of Dover, Ohio) are suggested melt stabilizers whereas hindered amine stabilizers (i.e. CHIMASSORB 944 and 119 available from Ciba Specialty Chemicals of Tarrytown, N.Y.) are suggested heat and light stabilizers. Packages of one or more of the above stabilizers are commercially available such as B900 available from Ciba Specialty Chemicals. B900 is a mixture of IRGAFOS 168 and IRGANOX 1076 additives. Desirably, about 100 to 2000 ppm of the stabilizers are added to the base polymer(s) prior to extrusion where ppm is parts per million in reference to the entire weight of the filled film layer formulation.

The amount of filler in the film and in the core layer can vary greatly. Additions of from 0 to 80 percent by weight based upon the total weight of the core layer 12 are possible. Generally, the fillers will be in particulate form and usually will have somewhat of an irregular shape with average particle sizes in the range of about 0.1 to about 7 microns. The term “particle size” as used herein refers to the longest single dimension of the particle. Furthermore, if sufficient filler is used in combination with sufficient stretching of the multilayer film 10, then voids can be created around the particles contained within the core layer 12 thereby making the core layer breathable. Loadings of about 40 to about 70 percent by weight of the core layer 12 when combined with stretching provides films which have good breathability. Such breathable films will generally have Water Vapor Transmission Rates (WVTR) in excess of 300 grams per square meter per 24 hours (g/m² /day) and more desirably WVTRs in excess of 800 g/m² /day; 2000 g/m² /day; 3000 g/m² /day, and even 4000 g/m² /day as measured by the test described above.

The skin layers 18 and 20 will typically include extrudable thermoplastic polymers and/or additives which provide specialized properties to the multilayer film 10. Thus, the first skin layer 18 and/or the second skin layer 20 may be made from polymers that include additives which provide such properties as antimicrobial activity, water vapor transmission, adhesion and/or antiblocking properties. Thus, the particular polymer or polymers chosen for the skin layer 18 and 20 will depend upon the particular attributes desired. Examples of possible polymers that may be used alone or in combination include homopolymers, copolymers and blends of polyolefins as well as polymers and/or copolymers of ethylene vinyl acetate (EVA), ethylene ethyl acrylate (EEA), ethylene acrylic acid (EAA), ethylene methyl acrylate (EMA), ethylene butyl acrylate (EBA), and/or ethylene vinyl alcohol (EVOH), and other thermoplastic polymers, including but not limited to, polyesters such a poly(ethylene terephthalate) (PET), nylons or polyamides (PA), polystyrene (PS), polyurethane (PU), homopolymers and copolymers of lactic acid (PLA) and olefinic thermoplastic elastomers which are multistep reactor products wherein an amorphous ethylene propylene random copolymer is molecularly dispersed in a predominately semicrystalline high polypropylene monomer/low ethylene monomer continuous matrix. Suggested commercially available resins that may be used to form the exterior layers include: Basell KS357 olefinic thermoplastic elastomer of from Himont USA of Wilmington, Del.; Ampacet 10115 antiblock from Ampacet Corporation of Tarrytown, N.Y. and EXXON XC-101 EMA copolymer.

In applications where good breathability (i.e. high WVTR) is desired, the skin layers preferably comprise, at least in part, an extrudable water vapor transmissive polymer. Examples of extrudable water vapor transmissive polymers include, but are not limited to, copolymers of ethylene and vinyl acetate, copolymers of ethylene and methyl acrylate, polystyrene, polyurethane, polyamide and mixtures thereof. It is suggested that the EVA copolymers and EMA copolymers contain no more than about 80 percent by weight of ethylene in the copolymer. Desirably the skin layer(s) comprise from about 30 weight percent to 100 weight percent of a water vapor transmissive polymer or a combination or of water vapor transmissive polymers and from 0 to about 70 weight percent of a polyolefin based polymer. It is suggested that the vapor transmissive polymer can comprise from about 40 to about 60 weight percent of the skin layer. Additionally, the skin layer can be water transmissive and may include two or more polymers such as, for example, 30 percent to 70 percent by weight EVA or EMA with 30 percent to 70 percent by weight polystyrene. The skin layer or layers may also include one or more fillers, for example stearic acid-coated calcium carbonate.

Films of the present invention include a surface that includes from about 0.01 to about 0.2 weight percent of a polyorganosiloxane or a mixture of polyorganosiloxanes relative to the total weight of the region proximate the surface of the film. The region proximate the surface or the exterior layer(s) may include from about 0.005 to about 0.15, from about 0.01 to about 0.15, from about 0.01 to about 0.10 or even from about 0.01 to about 0.075 weight percent of a polyorganosiloxane or a mixture of polyorganosiloxanes relative to the total weight of the region proximate the surface of the film. Suggested polyorganosiloxanes include, but are not limited to, polyorganosiloxanes of the following formula: 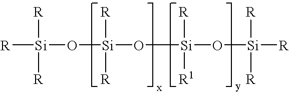
wherein R is an alkyl radical and R¹ is a monovalent organic radical containing at least one ethylene oxide group, vicinal epoxy group or amino group and x and y are independently selected from the group of positive integers. Such polyorganosiloxanes are described in U.S. Pat. No. 4,535,113. Other suggested polyorganosiloxanes are described in U.S. Pat. Nos. 4,857,593; 4,925,890; 4,931,492; and 5,003,023. A suggested commercially available example of such a polyorganosiloxane is SILQUEST® PA-1 organosilicone.

In addition, it may be desirable to add an anti-block material to improve processing and/or prevent unwanted adhesion of a tacky skin layer to other surfaces; as an example, some skin layers will adhere to the multilayer film itself when wound on a roll. Thus, it will often be desirable to add from 0 to about 10 percent anti-block material to the skin layers, and even more desirable from about 0.5 to about 5 percent by weight. Particulate matter such as diatomaceous earth or talc can be added to the skin layers, although other anti-block materials may be used including, but not limited to, ground silica, diatomaceous earth and so forth. Desirably the anti-block particles comprise particles having a median particle size of about 6-10 microns.

Oftentimes it may be desirable to laminate the multilayer film 10 to one or more substrates or support layers 30 such as is shown in FIG. 2. The film or the core layer of the film may not have sufficient adhesive or attachment properties so as to make it bondable to the support layer 30. As a result, the first skin layer 18 may comprise a polymer or polymers which exhibit higher adhesive properties and/or a lower tack point than the core layer 12.

A desired result with respect to the material of the present invention is to achieve a very low overall film thickness and more importantly, skin layers which are only a small percentage of the overall thickness of the multilayer film 10. As demonstrated by the examples below, based upon the overall thickness 28 of the multilayer film 10, in two layer constructions the first skin thickness 24 of the first skin layer 18 should not exceed more than 10 percent of the overall thickness 28. In three layer film constructions the combined thickness of the first skin layer 18 and second skin layer 20 should not exceed 15 percent of the overall thickness and generally, the first skin layer 18 should not exceed more than 7.5 percent and even more desirably each skin layer does not exceed over 5 percent of the overall film thickness 28. The same is also true with respect to the second skin layer 20 which can have the same thickness as the first skin layer 18 or a different thickness. In a further aspect, the skin layer or layers each have an individual thickness 24, 26 less than about 2 microns, desirably less than about 1.0 microns and still more desirably less than about 0.5 microns. As a result, the core thickness 22 comprises at least 85 percent of the overall thickness 28 and the first skin layer 18 and second skin layer 20 each generally will comprise no more than 7.5 percent of the overall thickness 28. Generally, it has been possible to create thinned films with overall thicknesses, about 30 microns or less and in certain applications with skin layers that do not exceed two microns. Desirably, the overall thickness 28 is less than about 25 microns and even more desirably less than about 20 microns. This is made possible by first forming a multilayer film 10 and then stretching or orienting the film in the machine direction, as explained in greater detail below, such that the resultant multilayer film 10 has increased strength properties in the machine direction or “MD”, i.e., the direction which is parallel to the direction of the film as it is taken off the film extrusion equipment.

The resultant film can, if desired, be laminated to one or more support layers 30 as are shown in FIG. 2. The support layers 30 as shown in FIG. 2 can be fibrous nonwoven webs. The manufacture of such fibrous nonwoven webs is well known to those of ordinary skill in the art of nonwoven manufacturing. Such fibrous nonwoven webs can add additional properties to the multilayer film 10 such as, a more soft, cloth-like feel. This is particularly advantageous when the multilayer film 10 is being used as a barrier layer to liquids in such applications as outer covers for personal care absorbent articles and as barrier materials for hospital, surgical, and clean room applications such as, for example, surgical drapes, gowns and other forms of apparel.

Attachment of the support layers 30 to the first skin layer 18 and second skin layer 20 may be by the use of a separate adhesive such as hot-melt and solvent based adhesives or through the use of heat and/or pressure as with heated bonding rolls. As a result, it may be desirable to design either or both the first skin layer 18 and the second skin layer 20 so as to have inherent adhesive properties to facilitate the lamination process. See for example, International Publication Number PCT WO 99/14045.

A particularly advantageous support layer is a fibrous nonwoven web. Such webs may be formed from a number of processes including, but not limited to, spunbonding, meltblowing, hydroentangling, air-laid and bonded carded web processes. Meltblown fibers are formed by extruding molten thermoplastic material through a plurality of fine, usually circular, die capillaries as molten threads or filaments into a high velocity usually heated gas stream such as air, which attenuates the filaments of molten thermoplastic material to reduce their diameters. Thereafter, the meltblown fibers are carried by the high velocity usually heated gas stream and are deposited on a collecting surface to form a web of randomly dispersed meltblown fibers. The meltblown process is well known and is described in various patents and publications, including NRL Report 4364, “Manufacture of Super-Fine Organic Fibers” by B. A. Wendt, E. L. Boone and C. D. Fluharty; NRL Report 5265, “An Improved Device For The Formation of Super-Fine Thermoplastic Fibers” by K. D. Lawrence, R. T. Lukas, J. A. Young; U.S. Pat. No. 3, 676,242, issued Jul. 11, 1972, to Prentice; and U.S. Pat. No. 3,849,241, issued Nov. 19, 1974, to Buntin, et al. The foregoing references are incorporated herein by reference in their entirety.

Spunbond fibers are formed by extruding a molten thermoplastic material as filaments from a plurality of fine, usually circular, capillaries in a spinnerette with the diameter of the extruded filaments then being rapidly reduced, for example, by non-eductive or eductive fluid-drawing or other well-known spunbonding mechanisms. The production of spunbond nonwoven webs is illustrated in patents such as Appel et al., U.S. Pat. No. 4,340,563; Matsuki, et al, U.S. Pat. No. 3,802,817; Dorschner et al., U.S. Patent No. 3,692,618; Kinney, U.S. Pat. Nos. 3,338,992 and 3,341,394; Levy, U.S. Pat. No. 3,276,944; Peterson, U.S. Pat. No. 3,502,538; Hartman, U.S. Pat. No. 3,502,763; Dobo et al., U.S. Pat. Nos. 3,542,615; 5,382,400 to Pike et al.; and Harmon, Canadian Patent no. 803,714. All of the foregoing references are incorporated herein by reference in their entirety. A 10 to 70 grams per square meter (gsm) spunbond web such as, for example, polypropylene fibers, is an exemplary support fabric.

Multilayer support layers 30 also may be used. Examples of such materials can include, for example, spunbond/meltblown laminates and spunbond/meltblown/spunbond laminates such as are taught in Brock et al., U.S. Pat. No. 4,041,203 which is incorporated herein by reference in its entirety. Bonded carded webs are made from staple fibers which are usually purchased in bales and may be used. The bales are placed in a picker which separates the fibers. Next the fibers are sent through a combing or carding unit which further breaks apart and aligns the staple fibers in the machine direction so as to form a machine direction-oriented fibrous nonwoven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calender rolls or ultrasonic bonding equipment is used to bond the fibers together, usually in a localized bond pattern though the web can be bonded across its entire surface if so desired. When using bicomponent staple fibers, through-air bonding equipment is, for many applications, especially advantageous.

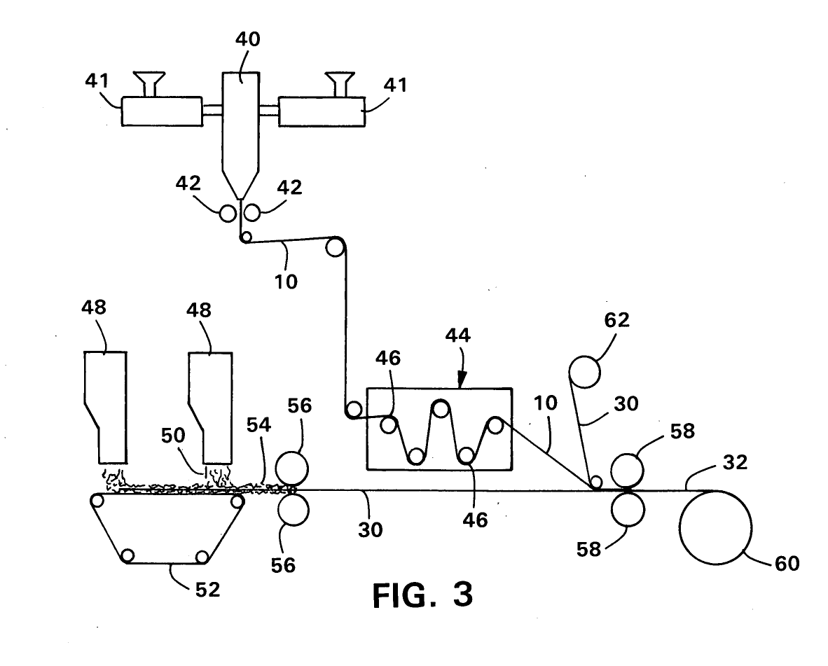

A process for forming the multilayer product film 32 is shown in FIG. 3 of the drawings. However, before a precursor film 10a is manufactured, the raw materials, i.e. the polymer(s) and filler must first be compounded through a process generally known to those skilled in the art. For instance, the raw materials can be dry mixed together and added into a hopper of a twin screw extruder. In the hopper, the materials are dispersively mixed in the melt and conveyed by the action of the intermeshing rotating screws. Upon exiting the twin screw extruder the material is immediately chilled and cut into pellet form.

Referring again to FIG. 3, the multilayer precursor film 10a is formed from a coextrusion film apparatus 40 such as a cast or blown unit as was previously described above. Typically the apparatus 40 will include two or more polymer extruders 41. The compounded material is first directed into the film extruder (hoppers). Typically, material for the skin layer(s) is added to a smaller extruder while material for the core layer is added to a larger main extruder. As is generally known to those skilled in the art, but is described herein in summary of for ease of reference, the extruder is equipped with a flow plate that joins and directs the flow of the two extruders into the cavity of a film die (the lower portion of 40). A flow plate is used so that the flow of the smaller (skin layer) extruder is split and directed around the flow of the main extruder, so that it sandwiches the flow of the main extruder. In this way a multiple (three) layered flow exits the slot of the extruder die.

The multilayer film 10a is extruded onto a chill roll 42, which may or may not be patterned. The flow out of the die 40 is immediately cooled on the chill roll 42. A vacuum box 43 situated adjacent the chill roll creates a vacuum along the surface of the roll to help maintain the precursor film 10a lying close to the surface of the roll. Additionally, air knives or electrostatic pinners 44 assist in forcing the precursor film 10a to the chill roll surface as it moves around the spinning roll. An air knife is a device known in the art which focuses a stream of air at a very high flow rate to the surfaces of the extruded polymer material. The result is the creation of a thin film with multiple layers. This thin precursor film 10a may be collected or subjected to further processing.

The three layer precursor film 10a construction, as initially formed, will have an overall thickness of approximately 2-3 millimeters and a basis weight of approximately 100 g/m² or greater, with the skin layers each having an initial thickness of 0.03-0.13 millimeters or greater, which collectively is approximately 3-5 percent of the overall initial precursor film thickness. The precursor film 10a may be subjected to further processing to make it more breathable. For example, from the coextrusion film apparatus 40, the precursor film 10a may be directed to a film stretching unit 47, such as a machine direction orienter or “MDO” which is a commercially available device from vendors such as the Marshall and Williams Company of Providence, R.I. The film stretching unit 47 includes a plurality of stretching rollers 46a-e which progressively stretch and thin the multilayer film in the machine direction of the film, which is the direction of travel of the film through the process as shown in FIG. 3. While the MDO is illustrated with five rolls, it should be understood that the number of rolls may be higher or lower depending on the level of stretch that is desired and the degrees of stretching between each roll. The film can be stretched in either single or multiple discrete stretching operations. Desirably, the unstretched filled film (precursor film) will be stretched from about 3 to about 6 times its original length, imparting a set in the stretched film 10b of between 3 to about 5 times of the original film length after the film is allowed to relax.

Referring again to FIG. 3, stretching rollers 46a and 46b may be heated to act as preheat rolls. These first few rolls heat the film slightly above room temperature (90° F.). Roller 46c may travel at a circumferential speed slower than the following roller 46d. The different speeds of the adjacent rollers act to stretch the filled precursor film 10a. The rate at which the stretch rolls rotate determines the amount of stretch in the film, and thus the level of breathability. One or both of the slow roller 46c and fast roller 46d can be also heated. After stretching, the film 10b may be allowed to slightly retract and/or be further heated or annealed by one or more heated rolls, such as by a heated anneal roller 46e. These rolls are typically heated to about 120° F. to anneal the film. After the film exits the MDO and is allowed to relax, it includes a set/elongation as compared to the original precursor film typically of between 3 and 5 times the original length of the film. This total final stretch allows for breathability and additional stretch in the product film in at least the cross-machine direction, of up to about 50 percent elongation.

After exiting the MDO film stretching unit 47, the then breathable product film desirably has a maximum thickness of approximately 0.6-1.2 millimeters and the skin layers desirably have a total maximum thickness of no more than about 0.018-0.04 millimeters, which in turn is collectively about 3 percent of the overall film. At this point the stretch thinned filled product film may be wound for storage or proceed for further processing. The product film is then itself capable of being stretched an additional length, such as up to about 50 percent in the CD and some additional stretch in the MD. If desired, the produced multilayer product film 10c may be attached to one or more support layers 30, such as fibrous layers, to form a multilayer film/laminate 32.

Suitable laminate materials include nonwoven fabrics, multi-layered nonwoven fabrics, scrims, woven fabrics and other like materials. In order to achieve a laminate with improved body conformance for personal care applications, the fibrous layer is desirably an extensible fabric and even more desirably an elastic fabric. For example, tensioning a nonwoven fabric in the MD causes the fabric to “neck” or narrow in the CD and give the necked fabric CD stretchability. Examples of additional suitable extensible and/or elastic fabrics include, but are not limited to, those described in U.S. Pat. No. 4,443,513 to Meitner et al.; U.S. Pat. No. 5,116,662 to Morman et al.; U.S. Pat. No. 4,789,699 to Kieffer et al.; U.S. Pat. No. 5,332,613 to Taylor et al.; U.S. Pat. No. 5,288,791 to Collier et al.; U.S. Pat. No. 4,663,220 to Wisneski et al.; and U.S. Pat. No. 5,540,976 to Shawver et al. The entire content of the aforesaid patents are incorporated herein by reference.

Nonwoven fabrics which are to be laminated to such multilayered films desirably have a basis weight between about 10 g/m² and about 70 g/m² and even more desirably between about 15 g/m² and about 34 g/m². As a particular example, a 17 g/m² (0.5 ounces per square yard) web of polypropylene spunbond fibers can be necked a desired amount and thereafter laminated to a breathable stretched filled-product film 10b. The product film 10b would therefore be nipped (in lamination rolls of a calender roll assembly) to a necked or CD stretchable spunbond nonwoven web.

The film and spunbond material typically enter the lamination rolls at the same rate as the film exits the MDO. The outer nonwoven layer can be laminated to the breathable, filled product film by one or more means known in the art. The nonwoven layer and filled-film can be bonded, e.g. point bonded, by imparting sufficient energy to the film and/or fibrous fabric to cause the materials to soften and/or flow such as, for example, by applying thermal, ultrasonic, microwave and/or compressive force or energy. As earlier discussed, bonding agents or tackifiers may be added to the film to improve adhesion of the layers. In a further aspect of the invention, the filled-film and fibrous layer can be adhesively laminated to one another. In order to achieve improved drape, the adhesive is desirably pattern applied to one of the fabrics or applied only to the outer fibrous layer. By applying the adhesive to the outer fibrous layer, such as a nonwoven fabric, the adhesive will generally only overlie the film at fiber contact points and thus provide a laminate with improved drape and/or breathability. Examples of suitable adhesives include, but are not limited to, REXTAC 2730 from Huntsman Corporation of Salt Lake City, Utah; H2525A which is a styrene block copolymer adhesive available from Findley Adhesives, Inc. of Wauwatusa, Wis.; and 34-5610 which is a styrene block copolymer adhesive available from National Starch, Starch and Chemical Co. of Bridgewater, N.J. Commercially available amorphous polyalphaolefins (APAO) used in hot melt adhesives suitable for use with the present invention include, but are not limited to, REXTAC ethylene-propylene APAO E-4 and E-5 and butylene-propylene BM-4 and BH-5 from Huntsman Corporation of Salt Lake City, Utah, and VESTOPLAST 792 from Huls AG of Marl, Germany. Desirably, about 1 g/m² to about 10 g/m² of adhesive is applied to a fibrous support fabric prior to superposing the support layer and filled-film. Additional bonding aids or tackifiers can also be used.

Referring again to FIG. 3, a process is shown for creating a three layered laminate (as seen in FIG. 2) from a prefabricated extensible nonwoven material. A stretched filled product film 10b is shown being attached to an extensible fibrous layer 30, such as a necked spunbond web, to form a film/nonwoven laminate. A neckable material 30 is unwound from a supply roll 62. The neckable material 30 then travels in the direction indicated by the arrows associated therewith. The neckable material 30 then passes through the nip 64 of S-roll arrangement 66, formed by a stack of rollers 68 and 70, in a reverse S-wrap path, as indicated by the arrows associated with stack rollers 68 and 70. Because the circumferential or peripheral speed of the rollers of the S-roll arrangement 66 is controlled to be slower than the peripheral line speed of the downline calender roll assembly 58, as seen in FIG. 3, the neckable material 30 is tensioned so that it necks a desired amount. The necked material 30 could alternatively be necked off-line and unrolled in the tensioned, necked condition. The necked material 30 is maintained in the tensioned, necked condition as it passes under spray equipment 72 which sprays an adhesive 73 through adhesive die head 74 into the necked material 30. Once the stretched filled product film 10b has been sufficiently thinned, the adhesive, necked material 30 and film 10bcan be brought together and the adhesive activated/treated (if necessary with heat) thereby forming the breathable laminate 32 as seen in FIG. 2.

Alternatively, a conventional fibrous nonwoven web forming apparatus, such as a pair of spunbond machines (not shown), may be used to form the support layer 30 in an in-line process. In such an in-line process, the long, essentially continuous fibers would be deposited onto a forming wire as an unbonded web. The unbonded web would then be sent through a pair of bonding rolls to bond the fibers together and increase the tear strength of the resultant web support layer. One or both of the rolls may be heated to aid in bonding. Typically, one of the rolls is also patterned so as to impart a discrete bond pattern with a prescribed bond surface area to the web. The other roll is usually a smooth anvil roll but this roll also may be patterned if so desired. Once the multilayer product film has been sufficiently thinned and oriented and the support layer has been formed, the two layers would then be brought together and laminated to one another using a pair of laminating rolls or other means.

As with bond rolls, the laminating rolls 58 may be heated. Also, at least one of the rolls may be patterned to create a discrete bond pattern with a prescribed bond surface area for the resultant laminate. Desirably, the maximum bond point surface area for a given area of surface on one side of the laminate will not exceed about 50 percent of the total surface area. There are a number of discrete bond patterns which may be used such as the H&P bond pattern, the C-star bond pattern or the Baby Object bond pattern. See, for example, International Publication PCT WO 99/14045 which is hereby incorporated herein by reference in its entirety. Once the laminate exits the laminating rolls, it would be wound up into a roll for subsequent processing. Alternatively, the laminate may continue in-line for further processing or conversion.

The process shown in FIG. 3 also may be used to create a three layer laminate 32 such as is shown-in FIG. 2 of the drawings. The only modification to the previously described process is to feed a supply 63 of a second fibrous nonwoven web support layer 30a into the laminating rolls 58 on a side of the multilayer product film 10b opposite that of the other fibrous nonwoven web support layer 30. As shown in FIG. 3, the supply of support layer 30 is in the form of a pre-formed roll 62. Alternatively, as with the other layers, the support layer 30 may be formed directly in-line. In either event, the second support layer 30a is fed into the laminating rolls 58 and is laminated to the multilayer product film 10c in the same fashion as the first support layer 30.

As has already been stated, once the laminate 32 is produced, the material continues on to the winder 60. As the material moves to the winder 60, it is allowed to retract. This is achieved by slowing the speed of the winder 60 to adjust for the retraction of the material. This process allows for machine direction stretch in the material since the spunbond has “bunched up” along with the retracting film and therefore has “give” when stretched in the machine direction in the finished laminate 32.

As has been stated previously, the multilayer product film 10b and the multilayered product film 10c in a laminate 32 may be used in a wide variety of applications including, but not limited to, personal care absorbent articles such as diapers, training pants, incontinence devices and feminine hygiene products such as sanitary napkins. An exemplary article 80, in this case a diaper, is shown in FIG. 4 of the drawings. Referring to FIG. 4, most such personal care absorbent articles 80 include a liquid permeable top sheet or liner 82, a back sheet or outercover 84 and an absorbent core 86 disposed between and contained by the top sheet 82 and back sheet 84. Articles 80 such as diapers may also include some type of fastening means 88 such as adhesive fastening tapes or mechanical hook and loop type fasteners.

The multilayer product film 10c by itself, or in other forms, such as the multilayer film/support layer laminate 32 may be used to form various portions of the article including, but not limited to, the top sheet 82 and the back sheet 84. If the film is to be used as the liner 82, it will most likely have to be apertured or otherwise made to be liquid permeable. When using a multilayer film/nonwoven laminate 32 as the outercover 84, it is usually advantageous to place the nonwoven side facing out away from the user. In addition, in such embodiments it may be possible to utilize the nonwoven portion of the laminate 32 as the loop portion of the hook and loop combination.

Other uses for the multilayer film and multilayer film/nonwoven laminates according to the present invention include, but are not limited to, surgical drapes and gowns, wipers, barrier materials and garments/articles of clothing or portions thereof including such items as workwear and lab coats. In this fashion, a higher cost, higher performance elastomer material may be efficiently used in less amounts in the skin layers of a multilayered film laminate to buttress the performance of a low performance elastomer, which makes up the majority of the film in the film core layer. By using the higher performance elastomer in the skin layer(s), the film retains a relatively high level of breathability and yet still demonstrates elastic behavior, particularly at approximately 50 percent stretch in the cross-machine direction. In particular, the high performance elastic skin layers will improve the retraction and reduce the percent set of the product film, that is the percentage of elongation at which the retraction tension goes to approximately zero.

### EXAMPLES

Highly Breathable Stretched Thin Laminate (HBSTL) films were manufactured by coextruding a three-layer ABA film that consisted of about 1.5 volume percent of layer A, 97 volume percent of layer B and 1.5 volume percent of layer A, respectively. The films were produced using a commercial manufacturing method similar to the method schematically illustrated in FIG. 3 and generally described above. The composition of interior “core” (B) layer consisted of:

1) about 60 weight percent of stearic-coated calcium carbonate;

2) about 40 weight percent of a mixture of two linear low-density polyethylenes (LLDPE) that included from about 15-20 weight percent of DOWLEX 2517 LLDPE and from about 20-30 weight percent of DOWLEX 2047 LLDPE; and

3) about 0.3-0.4 weight percent of B900 antioxidant obtained from Ciba. The composition of each of the exterior “skin” layers (A) consisted of:

1) about 50 weight percent of a mixture of two copolymers of ethylene and vinyl acetate (EVA) that included 25 weight percent of Exxon LD761.36 EVA resin and 25 weight percent of Exxon LD755.12 EVA resin;

2) about 49.8 weight percent of Basell KS357P propylene-ethylene copolymer;

3) 0.05 weight percent (about 500 ppm) of SILQUEST® ( PA-1 processing additive obtained from OSi Specialties, a division of Crompton Corporation of Greenwich, Conn.;

4) 0.075 weight percent of 1078 antioxidant obtained from Ciba Specialty Chemicals of Tarrytown, N.Y.; and

5) 0.075 weight percent of 1078 antioxidant also obtained from Ciba Specialty Chemicals.

SILQUEST® PA-1 silicon-based processing additive was included in only the exterior layers, specifically the A composition that was used to form the exterior A layers to reduce die-lip build-up of the film on the extrusion die while minimizing the amount of total additive that is needed. SILQUEST® PA-1 additive is an organomodified polydimethylsiloxane (PDMS) that is supplied as a liquid. SILQUEST® PA-1 silicon-based processing additive has a boiling point greater than 150° C. at STP, a melting point less than 0° C. at STP and a specific gravity of 1.0200 at 25° C. (1,013 hPa). Again, SILQUEST® PA-1 processing additive is generally described in U.S. Pat. No. 4,535,113 to Union Carbide Corporation according to the following formula:

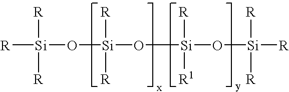

wherein R may be an alkyl radical and R¹ may be a monovalent organic radical containing at least one ethylene oxide group, vicinal epoxy group or amino group and x and y may each be a positive integer.

The coextruded films were stretched about 3-4 times in length according to the process generally illustrated in FIG. 3 to form a stretched, breathable film with a final total thickness of about 16 microns of which each A layer is about 0.3-0.6 microns in thickness. The coextruded multilayer films were then laminated to two nonwoven layers of a 0.5 once per square yard (osy) polypropylene spunbonded nonwoven fabric to form a multilayer film/nonwoven laminate as illustrated in FIG. 2. The film and the two layers of spunbonded fabric were thermally point bonded to produce a laminate.

### Example 1 and Control Example A

Coextrusion of the multilayer film including SILQUEST® PA-1 in the exterior layers as described above was run on a commercial scale apparatus under commercial speeds and conditions for about 24 hours, Example 1. The trial was successful. Processing conditions and properties were at parity with standard production conditions and properties. Noticeably, no unusual die lip build up was observed and the process did not have to be stopped to remove die lip build up.

A control sample, i.e. a laminate sample produced without SILQUEST® PA-1 additive, was manufactured under the same processing conditions, Control Example A. Random samples of Example 1 made with SILQUEST® PA-1 additive and the Control Example A were tested using the peel strength test described above to determine if addition of polydimethylsiloxane processing aid detrimentally affected peel strength of the fabric/film/fabric laminate in the machine direction (MD). The average peel strength of the Example 1 laminates that included SILQUEST® PA-1 additive was 116 grams with a standard deviation of 7.3 grams. The average peel strength of the Control Example A laminates that did not include SILQUEST® PA-1 additive was 147 grams with a standard deviation of 30.8 grams.

### Example 2 and Control Example B

A second trial was conducted using the same conditions and formulation to evaluate the formulation and process for a longer period of time. The second trial was conducted for 7 days instead of 24 hours, Example 2. Again, processing conditions and properties were at parity with standard production conditions and properties and no unusual die lip build up was observed. Advantageously the manufacturing process did not have to be stopped to remove die lip build up during the entire 7 day trial period as opposed to having to stop production every few hours when no processing aid is included.

A control sample, i.e. a laminate sample produced without SILQUEST® PA-1 additive, was manufactured under the same processing conditions, Control Example B. Random samples of Example 2 made with SILQUEST® PA-1 additive and the Control Example B also were tested to determine if addition of polydimethylsiloxane processing aid detrimentally affected peel strength of the fabric/film/fabric laminate. The average peel strength of the Example 2 laminates that included SILQUEST® PA-1 additive was 119 grams with a standard deviation of 11.6 grams. The average peel strength of the Control Example B laminates that did not include SILQUEST® PA-1 additive was 155 grams with a standard deviation of 18.5 grams.

### Example 3 and Control Example C

Finally, a third production trial was conducted using the same conditions and formulation to evaluate the formulation and process for an even longer period of time. The third trial was conducted for about one month and included changing the multilayer film formulation by reducing the amount of filler in the interior B core layer to about 45 weight percent calcium carbonate treated with stearic acid. Processing conditions and properties were at parity with standard production conditions and properties for both multilayer films. No unusual die lip build up was observed during the entire 30 day trial period. Specifically, the process did not have to be stopped to remove die lip build up during the entire 30 day trial period.

A control sample, i.e. a laminate sample produced without SILQUEST® PA-1 additive, was manufactured under the same processing conditions, Control Example C. Random samples of Example # made with SILQUEST® PA-1 additive and the Control Example C were tested to determine if addition of polydimethylsiloxane processing aid detrimentally affected peel strength of the fabric/film/fabric laminate. The average peel strength of the Example 3 laminates that included SILQUEST® PA-1 additive was 120 grams with a standard deviation of 7.4 grams. The average peel strength of the Control Example C laminates that did not include SILQUEST® PA-1 additive was 163 grams with a standard deviation of 19.3 grams.

While the present invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that o f the appended claims and any equivalents thereto.

1. (canceled)

2. (canceled)

3. (canceled)

4. (canceled)

5. (canceled)

6. (canceled)

7. (canceled)

8. (canceled)

9. (canceled)

10. A process for reducing die lip build up during melt extrusion of a film, the process comprising:
providing a first molten thermoplastic composition and a second molten thermoplastic composition; and
forming the first thermoplastic composition and the second molten thermoplastic composition into a film;
wherein the second molten thermoplastic composition comprises an amount of a polyorganosiloxane or a mixture of polyorganosiloxanes that is greater than the amount of polyorganosiloxane or a mixture of polyorganosiloxanes contained in the first thermoplastic composition.

11. The process of claim 10 wherein the polyorganosiloxane is a polyorganosiloxane selected from the group of polyorganosiloxanes of the following formula: 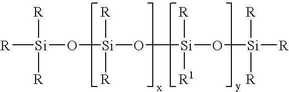
wherein R is an alkyl radical and R¹ is a monovalent organic radical containing at least one ethylene oxide group, vicinal epoxy group or amino group and x and y are independently selected from the group of positive integers.

12. The process of claim 10 wherein the amount of polyorganosiloxane in the second thermoplastic composition ranges from about 0.01 to about 0.2 weight percent of a polyorganosiloxane or a combination of polyorganosiloxanes relative to the total weight of the second thermoplastic composition.

13. The process of claim 10 wherein the amount of polyorganosiloxane in the second thermoplastic composition ranges from about 0.01 to about 0.15 weight percent of a polyorganosiloxane or a combination of polyorganosiloxanes relative to the total weight of the second thermoplastic composition.

14. The process of claim 10 wherein the amount of polyorganosiloxane in the second thermoplastic composition ranges from about 0.01 to about 0.10 weight percent of a polyorganosiloxane or a combination of polyorganosiloxanes relative to the total weight of the second thermoplastic composition.

15. The process of claim 10 wherein the amount of polyorganosiloxane in the second thermoplastic composition ranges from about 0.01 to about 0.075 weight percent of a polyorganosiloxane or a combination of polyorganosiloxanes relative to the total weight of the second thermoplastic composition.

16. The process of claim 10 wherein the film is a multilayer film comprising at least one interior layer and two exterior layers, the exterior layers comprises the second thermoplastic composition and the polyorganosiloxane or a mixture of polyorganosiloxanes is included in the exterior layers at an amount that ranges from about 0.01 to about 0.2 weight percent of the exterior layers.

17. The process of claim 10 wherein the film is a breathable liquid barrier and has a WVTR of at least about 300 g/m²/24 hours.

18. The process of claim 10 wherein the film is a breathable liquid barrier and has a WVTR of at least about 300 g/m²/24 hours.

19. (canceled)

20. (canceled)

21. (canceled)

22. (canceled)

23. (canceled)

24. (canceled)

25. (canceled)
